(19) United States
(12) Patent Application Publication
(10) Pub. No.: US 2008/0037486 A1
(43) Pub. Date: Feb. 14, 2008

(54) Methods And Apparatus Managing Access To Virtual Private Network For Portable Devices Without Vpn Client

(76) Inventors: Olivier Gerling, Noisy Le Roi (FR); Junbiao Zhang, Beijing (CN); Kumar Ramaswamy, Princeton, NJ (US)

Correspondence Address: THOMSON LICENSING LLC, Two Independence Way, Suite 200, PRINCETON, NJ, 08540, US

(21) Appl. No.: 11/596,949

(22) PCT Filed: May 10, 2005
(86) PCT No.: PCT/US05/16378

§ 371 Date: Sep. 20, 2007

Related U.S. Application Data
(60) Provisional application No. 60/571,742, filed on May 17, 2004.

(51) Int. Cl. H04L 29/06; H04L 12/56

(52) U.S. Cl. 370/338; 709/229; 726/15

(57) ABSTRACT

A portable communications device advantageously can access an enterprise network through a Virtual Private Network link without the need for a VPN client. To accomplish communications, the portable communications device establishes a communication link with a wireless access point using one or several well-known secure wireless protocols. The wireless access point establishes a communication link with the enterprise network through the VPN and bridges the connections to afford an end-to-end link between the portable computing device and the enterprise network.

### CROSS-REFERENCE TO RELATED APPLICATIONS

This application claims priority under 35 U.S.C. 119(e) to U.S. Provisional Patent Application Ser. No. 60/571742, filed on May 17, 2004, the teachings of which are incorporated herein.

### TECHNICAL FIELD

This invention relates to a technique for managing a secure connection between a wireless device and a network.

### BACKGROUND ART

Many individuals increasingly make use of one or more portable communication devices in the course their daily pursuits. Such portable devices include lap top computers, Personal Digital Assistants (PDAs) and wireless telephones. These portable communications devices offer the capability of accessing a communications network via a wireless connection. Wireless telephones, as well as some types of PDAs allow a user to access a public wireless telephony network. Present day public wireless telephony networks typically make use of one of several well-known wireless standards, such as Time Division Multiple Access (TDMA), Code Division Multiple Access (CDMA), Global Standard for Mobile (GSM) and the third generation cellular phone standard. Many lap top computers offer wireless connectivity through public networks that make use of the IEEE 802.11i standard. For many users, access to a public wireless network enables subsequent access to an enterprise network, the intended destination for communications.

In the past, most enterprise networks relied on leased line connections with one or more public networks to enable user access. Leased line connections offer high security, but at a high cost. With advent of the Internet, public network providers now offer enterprise network operators the ability to create a Virtual Private Network (VPN) within the public network. Such VPNs use virtual connections to simulate the equivalent of a private leased-line network, but at a reduced cost.

Within a given public network, several VPNs can share a common communications path. Thus, security remains important to make sure that unintended recipients cannot access data destined for a particular enterprise network. Various security techniques exist within VPN networks. Such techniques often make use of different encryption techniques, including symmetric key and public key encryption. Some VPNs make use of the Internet Protocol Security Protocol (IPSEC). To enable a portable communications device to establish an end-to-end connection via a VPN to an enterprise network, the communications device must include a VPN client, which takes the form of hardware and/or software necessary to implement the various security protocols. While some portable communications devices such as lap top computers possess the ability to incorporate a VPN client, many smaller devices, such as wireless telephones and PDAs do not. Thus, such smaller portable communications devices cannot readily establish a connection to an enterprise network across a VPN.

Thus a need exists for a technique for enabling a portable communications device to establish a connection with an enterprise network at least in part across a VPN.

### BRIEF SUMMARY OF THE INVENTION

Briefly, in accordance with a preferred embodiment of the present principles, there is provided a method for establishing connection between a portable communications device and an enterprise network. The method commences upon the receipt at a wireless access point of a request by the portable communications device for access to an enterprise network. Responsive to the access request, the wireless access point determines the identity of the enterprise network, which the portable communications device seeks to access. The wireless access point authenticates the portable communications device using a wireless authentication protocol. Upon successful authentication of the portable communications device, the wireless access point establishes a Virtual Private Network with the identified enterprise network to facilitate communications between the portable communications device and the enterprise network. In this way, the wireless access point establishes a connection utilizing the wireless LAN security mechanism as between the portable device and the access point, and a VPN connection between the access point and the enterprise network.

### BRIEF SUMMARY OF THE DRAWINGS

FIG. 1 depicts a block schematic diagram of a wireless network according to the prior art in which a portable communications device includes a VPN client for communicating with an enterprise network across an end-to-end VPN connection; and

FIG. 2 depicts a block schematic of a wireless network according to the present principles in which a portable communications device communicates with an enterprise network in part across a VPN connection without the need for the portable device to include a VPN client.

### DETAILED DISCUSSION

To best understand the technique of the present principles for facilitating communications between a portable communications device and an enterprise network in part across a VPN without the need for a VPN client at the portable communications device, a brief discussion of the prior art technique will prove helpful.

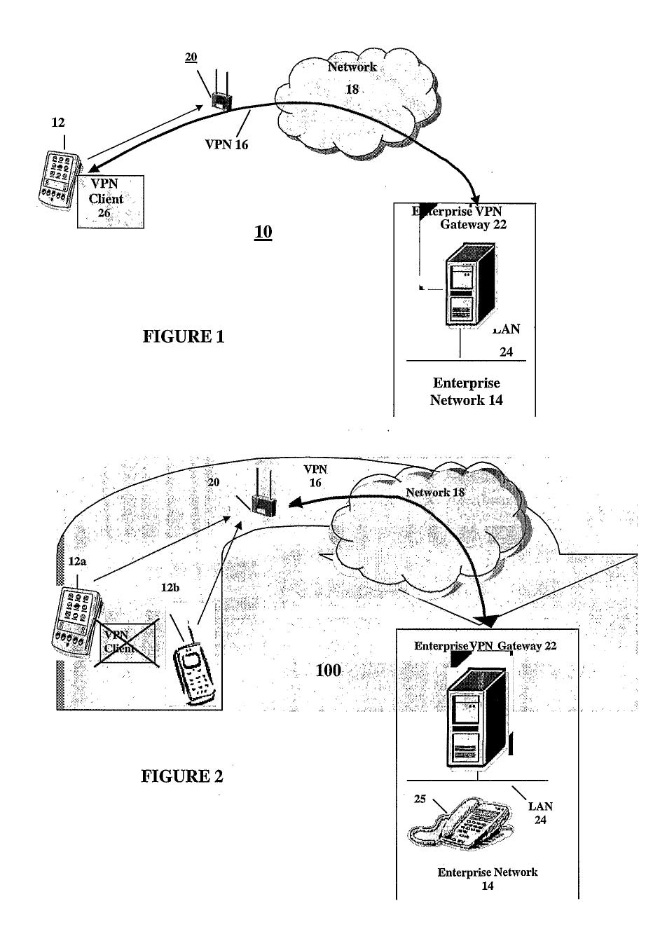

FIG. 1 depicts a block schematic diagram of a prior art communications network 10 in which a portable communications device 12, such as a lap top computer, wireless telephone or PDA, establishes an end-to-end communications link with an enterprise network 14 via Virtual Private Network (VPN) 16. The VPN 16 extends between the enterprise network 14 and the portable communications device 12 through a public network 18 and a wireless access point 20. Although shown as a single entity, the wireless access point 20 can comprise part of a wireless network, not shown. In the illustrated embodiment, the enterprise network 14 includes an enterprise gateway server 20 coupled to a Local Area Network 24.

In order for the portable communications device 12 to establish an end-to-end communications link with the enterprise network 14 through the VPN 16, the portable communications device 12 must possess a VPN Client 26. The VPN client 26 takes the form of one or more programs and associated data, and possibly one or more hardware elements (not shown) that enable the portable communications device 12 to interface with the VPN 16, taking into account the applicable security protocol(s). While some portable communications devices such as lap top computers possess the ability to incorporate the VPN client 22, other portable communications devices with lesser resources, such as a wireless telephone device do not possess such capability. Thus, portable communications devices with limited resources lack the capability of establishing a communications link with the enterprise network 14 across the VPN 16.

FIG. 2 depicts a block schematic diagram of a communications network 100 in accordance with a preferred embodiment of the present principles for enabling or more portable communications devices, such as devices 12a and 12b, to establish communications with an enterprise network 14 at least in part across a Virtual Private Network (VPN) 16. The network 100 of FIG. 2 possesses many of the same elements as the network 10 of FIG. 1 and therefore, like numbers reference like elements.

The network 100 of FIG. 2 differs from the network 10 of FIG. 1 in one significant respect. Unlike the network 10 of FIG. 1 in which the portable communications device 12 includes the VPN client 26, neither of the portable communications device 12a and 12b in the network 100 of FIG. 2 includes a VPN client. Rather than establish an end-to end communications link with the enterprise network 14 through VPN 16 as in FIG. 1, each of the portable communications devices 12a and 12b first establish a communications link with the wireless access point 20, using one of several well-known wireless communications protocols. Thus for example, should one of the portable communications device 12 and 12b comprise a wireless telephone or PDA, communications between that device and the wireless access point 20 typically would occur using any of several well-known wireless telephone communications protocols, such as CDMA, TDMA, GSM, 3G or the like. Depending on their configuration, one or both of the portable communications devices 12a and 12b could communicate with the wireless access point 20 using the IEEE 802.11i protocol. Communication via wireless protocols other than those previously mention can also occur.

Once one of the portable communications devices 12a and 12b has established a communications link with the wireless access point 20, the wireless access point then seeks to identify the enterprise network that the portable communications device seeks to access to enable authentication. The wireless access point 20 identifies the enterprise network 14 in at least one of two ways. For example, the credentials associated with the user of the portable communications device can identify the enterprise network 14. For example, a user's credential contains will include the user's name, i.e., bob@thomson.net, with the domain portion of the user name specifying the enterprise network. The user could also specifically identify the enterprise network 14 that he or she seeks to access.

The wireless access point 20 authenticates the user of the portable communication device by consulting the enterprise network 14, which can verify the user's credential. Such authentication can occur through using the IEEE 802.11i communications protocol between the wireless access point 20 and the portable communications device. As between the wireless access point 20 and the enterprise network 14, the RADIUS communications protocol could be used. Upon successful authentication, the wireless access point 20 builds a secure session with one of the portable communications devices 12a and 12b using the wireless LAN security mechanism e.g. Temporal Key Integrity protocol, (TKIP), Wi-Fi Protected Access (WPA) or Advanced Encryption standard (AES).

The wireless access point 20 also builds a VPN between itself and the enterprise network 14 on behalf of the portable communications device, using the regular VPN model, such as through IPSEC. The wireless access point 20 bridges these two secure connections to build an end-to-end connection between the portable device and the enterprise network. Note that the VPN connection between the wireless access point 20 and the enterprise network 14 can be pre-built as a single VPN session. Note that the wireless access point 20 must have the trust of the enterprise network 14, thus introducing an additional level of complexity as compared to the end-to-end VPN solution of FIG. 1 in which the intermediate networks do not have to be trusted.

The foregoing describes a technique for enabling a communications device to establish a with an enterprise network without the need for the portable computing device to possess a VPN client.

1-9. (canceled)

10. A method for establishing connection between a network client-free portable communications device and an network, comprising the steps of: receiving at a wireless access point a request for access to a network from a portable communications device;
determining at the wireless access point which network the portable communication device seeks to access:
authenticating the network client-free portable communications device at the wireless access point using a wireless access authentication protocol to create a wireless communications link with the portable communications device;
establishing virtual private network connection to the network to be accessed by the network client-free portable communications device to provide a connection via the access point between the portable communications device and the network; and
bridging the wireless communications link and the virtual private communications connection.

11. The method according to claim 10 wherein the step of determining step further comprises the steps of:
receiving an identifying credential from the portable communications device seeking access to the network;
identifying the network from the identifying credential.

12. The method according to claim 10 wherein the step of determining step further comprises the steps of:
receiving from the portable communications device seeking access to the network a network identification; and
identifying the network from the network identification.

13. The method according to claim 10 wherein the authentication step further comprises the step of consulting the network to verify credentials of the portable communications device.

14. The method according to claim 10 wherein the authenticating step further comprises authenticating the portable communications device using one of a temporal key integrity protocol, wi-fi protected Access protocol or an advanced encryption standard protocol.

15. A method for operating a network client-free portable communications device to access an network, comprising the steps of:
sending from the portable communications device a request for access for receipt by a wireless access point;
supplying an indication by the portable communications device of the identity of the network to be accessed for receipt by the wireless access point;
providing authenticating information from the network client-free portable communications device to the wireless access point to enable the wireless access point to establish a wireless communications link with the portable communications device and to enable the wireless access point to establish a VPN connection with the network so that wireless access point can bridge the VPN connection and wireless communications link.

16. Apparatus for establishing connection between a network client-free portable communications device and an network, comprising:
means for receiving at a wireless access point a request for access to an network from a portable communications device;
means for determining at the wireless access point which network the portable communication device seeks to access:
means for authenticating the network client-free portable communications device at the wireless access point using a wireless access authentication protocol to create a wireless communications link with the portable communications device;
means for establishing virtual private network connection to the network to be accessed by the network client-free portable communications device to provide a connection via the access point between the portable communications device and the network; and
means for bridging the wireless communications link and the virtual private communications connection.

17. The apparatus according to claim 16 wherein the determining manes further comprises:
means for receiving from the portable communications device seeking access to the network a network identification; and
means for identifying the network from the network identification.
